(19) United States
(12) Patent Application Publication
(10) Pub. No.: US 2006/0175959 A1
(43) Pub. Date: Aug. 10, 2006

(54) Green enhancement filter to improve yield of white displays

(75) Inventors: Vi-En Choong, San Jose, CA (US); Brian Cumpston, Pleasanton, CA (US)

Correspondence Address: EPPING, HERMANN, FISCHER, Ridlerstrasse 55, Munich, 80339, DE

(73) Assignee: Osram Opto Semiconductors GmbH

(21) Appl. No.: 11/195,304

(22) Filed: Aug. 1, 2005

Related U.S. Application Data
(60) Provisional application No. 60/651,692, filed on Feb. 9, 2005.

(51) Int. Cl. H05B 33/14; H05B 33/22

(52) U.S. Cl. 313/504; 313/503; 313/506

(57) ABSTRACT

Disclosed is an organic electroluminescent device, comprising: 1) an organic light emitting diode (OLED); and 2) a color enhancement filter disposed in the path of light emission from said OLED and external to said OLED, said filter shifting the color of said light emission in a desirable manner without adversely affecting the intensity of said light emission.

### RELATED APPLICATIONS

This application claims priority to a U.S. provisional patent application entitled “Green Enhancement filter to improve yield of white displays,” filed on Feb. 9, 2005, bearing Ser. No. 60/651,692.

### BACKGROUND

1. Field of the Invention

This invention relates generally to the art of thin film device processing and fabrication. More specifically, the invention relates to the structure of Organic Light Emitting Diode devices and displays.

2. Related Art

A typical structure of a polymer light-emitting diode (PLEDs) consists of a hole injection electrode (anode), a layer of light-emitting polymer (LEP) and an electron injection electrode (cathode). Usually the anode layer consists of a transparent conducting film such as indium-tin-oxide (ITO) with a layer of conducting polymer, such as poly(3,4-ethylenedioxythiophene) doped with poly(styrene sulphonate) (PEDOT:PSS). The purpose of the PEDOT:PSS layer is to improve hole injection into the LEP by increasing the workfunction of the injection layer and providing a better physical contact between the LEP and the injection layer. The cathode layer is typically a layer of low workfunction metal, such as Ba or Ca, capable of effectively injecting electrons into the LEP layer, capped with a layer of another metal such as Al.

The color of light emission from such a device structure is controlled by emission properties of the LEP layer. For example, white emission can be achieved by blending a blue-emitting LEP with polymers (or small molecules) that emit in green and red regions of spectrum. In this case direct carrier trapping and/or energy transfer from the blue host to the red and green dopants will redistribute emission between blue, green and red chromophores thus resulting in white emission. A similar approach is to synthesize a copolymer incorporating all three types of chromophores in one polymer chain thus preventing possible phase separation that may occur in a blend.

However the above approaches have several drawbacks:

(1) Since only very small concentration of the emitting dopants are required to change the color of emission, the tolerances of the concentrations of these dopants in the host LEP have to be very tight in order to have sufficient reproducibility.

(2) In addition to affecting the color, changing the concentrations of the emitting dopants, or changing the dopant can also result in undesirable changes in charge transport (e.g. trapping of charges) properties of the host LEP which can adversely affect device performance.

(3) The stability of these emitting chromophores in the host and in the presence of each other across the operational life of the device is also an issue as illustrated in FIG. 1. Although in theory, any issue with the color of the display can be corrected by adjusting the concentrations of the dopants, or replacing the dopants with other dopants, in practice that task is made difficult as finding a dopant system that satisfy all three factors cited above is very difficult. For example, the situation may arise that the dopant system chosen can produce the desired color, and that the dopants are stable during operation satisfying factor 3. Furthermore, the concentration of these dyes that are needed is relatively high, thus increasing the tolerance for the concentrations (factor 1) enough to produce reasonable yields. However, with such a high concentration, the dopants may either self-quench to reduce the efficiency of the device, or cause an imbalance in the charge transport properties of the device thus affecting both the efficiency and reliability of the device. Solving these problems through material selection is an arduous and sometimes impossible task. Thus, there exists a need to solve this problem without affecting the performance of the device.

### BRIEF DESCRIPTION OF THE DRAWINGS

FIG. 1 illustrates color stability as a function of operational device lifetime.

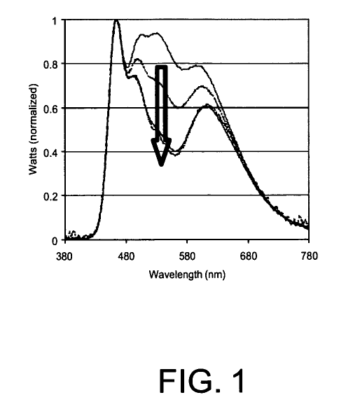

FIG. 2 illustrates a white spectrum.

FIG. 3 illustrates a filter that that can be utilized in various embodiments of the invention.

FIG. 4 illustrates comparison of EL spectra with and without green enhancement filter.

FIG. 5 shows a cross-sectional view of an embodiment of an electroluminescent (EL) device 200 according to at least one embodiment of the invention.

### DETAILED DESCRIPTION OF THE INVENTION

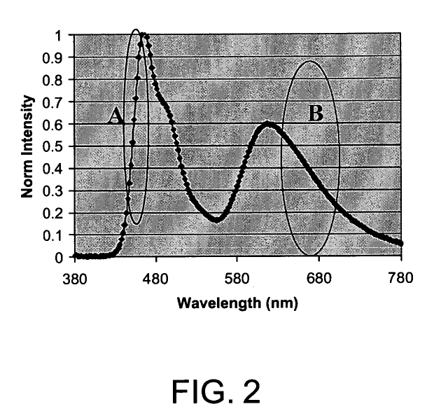

In one or more embodiments of the invention, what is disclosed is the use of external color enhancement filters to increase the color yield while not affecting the performance of the device. The invention provides guidelines for the choice of these filters such that the intensity is not significantly affected by the filter, and the desired result is obtained. The invention involves the adjustment of the emission spectra of the display to obtain a good white color and increase the color yield. This adjustment is done using an externally applied color enhancement filter. The shape of the filter transmission should be specified such as to provide the proper amount of adjustment while preserving the intensity of the display. To illustrate this, consider the white spectrum in FIG. 2. The spectrum is off white, pinkish. From a material perspective, to adjust this spectrum to obtain white, one either has to add another emitter, (green in this case), or modify the properties of the blue emitter. Either proposition has its drawbacks as cited above. In accordance with the invention, an externally applied color enhancement filter that depresses regions A and B sufficiently can shift the CIE (Commission Internationale de l'Eclairage) coordinates towards the ideal white CIE coordinates of x=0.330, y=0.330. The extent of depression in these regions as well as overall transmission should be controlled so as not to impact the final intensity of the display. FIG. 2 illustrates a near white spectrum with CIE coordinates x=0.337, y=0.283. Regions A and B demark areas in the spectrum that need to be attenuated to bring CIE coordinates closer to an ideal white.

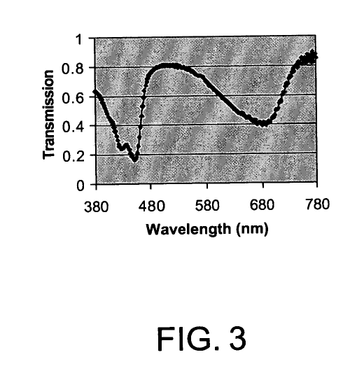

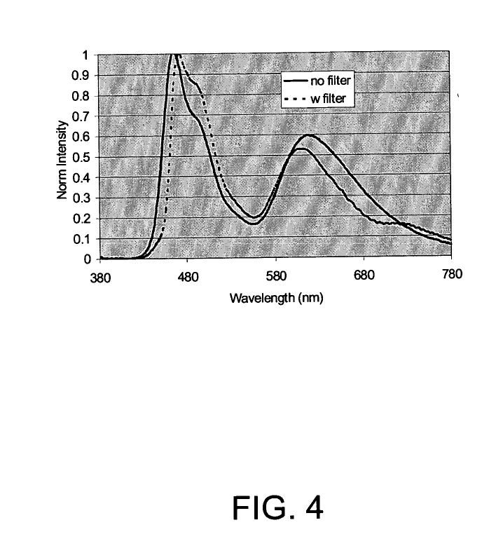

A good example of a filter that that can be utilized in various embodiments of the invention is shown in FIG. 3. The extreme blue region of the spectra is attenuated more than the red region of the spectrum as required. By using this filter, the CIE coordinates of the output emission was shifted from x=0.337, y=0.283, to x=0.336, y=0.338. This adjustment was done at a cost of 22% luminance lost. The final spectrum is shown in FIG. 4. By shifting the CIE coordinate to ideal white, a larger tolerance is afforded for color variation. If the display CIE coordinates is at ideal white, then variation in both positive and negative directions in the CIE space is allowable. However, if the display CIE coordinates is less than ideal (e.g. containing too much blue or red), then any variation in the wrong direction could result in a noticeable color change (e.g. variation towards blue in a display that almost contains too much blue).

FIG. 4 illustrates comparison of emission spectra with and without green enhancement filter. The green enhancement filter adjust the color from magenta to white. Likewise, color filters with different transmission characteristics can be used to tune the color of other LEP materials. Small changes in the output spectrum can be achieved with small luminance loss, but larger changes will result in greater loss and must be weighed against improved color and/or higher color yield.

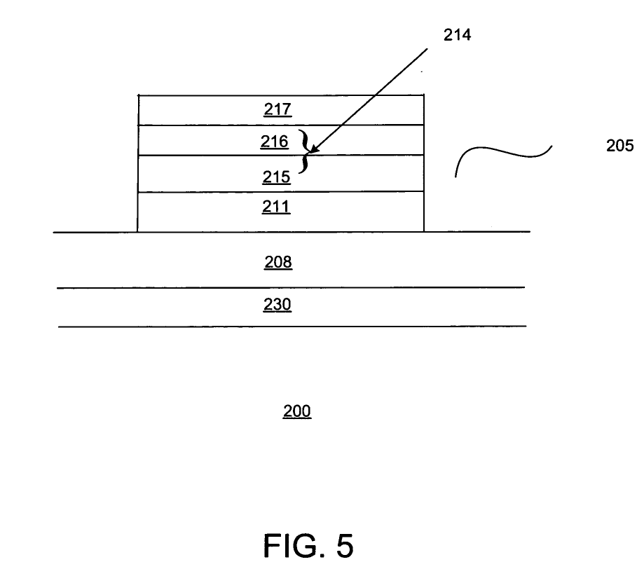

FIG. 5 shows a cross-sectional view of an embodiment of an electroluminescent (EL) device 200 according to at least one embodiment of the invention. The EL device 200 includes an OLED device 205. OLED device 205 includes substrate 208 and a first electrode 211 on the substrate 208. The first electrode 211 may be patterned for pixilated applications or un-patterned for backlight or other general lighting applications. The OLED device 205 also includes a semiconductor stack 214 on the first electrode 211. The semiconductor stack 214 includes at least the following: (1) a hole injection layer/anode buffer layer (HIL/ABL) 215 and (2) an active light emissive layer (EML) 216.

As shown in FIG. 5, the OLED device 205 is a bottom-emitting device. As a bottom-emitting device, the first electrode 211 would act as an anode, and the HIL/ABL 215 would be disposed on the first electrode 211, and the EML 216 would be disposed on the HIL/ABL 215. The OLED device 205 also includes a second electrode 217 on the semiconductor stack 214. Other layers than that shown in FIG. 5 may also be added such as insulating layers, barrier layers, electron/hole injection and blocking layers, getter layers, and so on. In accordance with the invention, an enhancement filter 230 is disposed on the outside of the OLED device 205. More specifically, in the configuration shown, the enhancement filter 230 is disposed on the substrate 208. The OLED device 205 and the enhancement filter 230 together comprise the EL device 200. Exemplary embodiments of these layers are described in greater detail below.

Substrate 208:

The substrate 208 can be any material, which can support the additional layers and electrodes, and is transparent or semi-transparent to the wavelength of light emitted by the OLED device 205. Preferable substrate materials include glass, quartz, silicon, and plastic, preferably, thin, flexible glass. The preferred thickness of the substrate 208 depends on the material used and on the application of the device. The substrate 208 can be in the form of a sheet or continuous film. The continuous film is used, for example, for roll-to-roll manufacturing processes which are particularly suited for plastic, metal, and metallized plastic foils.

First Electrode 211:

In the bottom-emitting configuration, the first electrode 211 functions as an anode (the anode is a conductive layer which serves as a hole-injecting layer). Typical anode materials include metals (such as platinum, gold, palladium, indium, and the like); metal oxides (such as lead oxide, tin oxide, indium-tin oxide, and the like); graphite; doped inorganic semiconductors (such as silicon, germanium, gallium arsenide, and the like); and doped conducting polymers (such as polyaniline, polypyrrole, polythiophene, and the like). Preferably, the first electrode 211 is comprised of indium-tin oxide (ITO).

The first electrode 211 is preferably transparent or semi-transparent to the wavelength of light generated by the OLED device 205. Preferably, the thickness of the first electrode 211 is from about 10 nanometers (“nm”) to about 1000 nm, more preferably from about 50 nm to about 200 nm, and most preferably is about 100 nm to 150 nm.

The first electrode layer 211 can typically be fabricated using any of the techniques known in the art for deposition of thin films, including, for example, vacuum evaporation, sputtering, electron beam deposition, or chemical vapor deposition, using for example, pure metals or alloys, or other film precursors.

HIL/ABL 215:

The HIL/ABL 215 has good hole conducting properties and is used to effectively inject holes from the first electrode 211 to the EML 216. The HIL/ABL 215 is made of polymers or small molecule materials or other organic or partially organic material. For example, the HIL/ABL 215 can be made from tertiary amine or carbazole derivatives both in their small molecule or their polymer form, conducting polyaniline (“PANI”), or PEDOT:PSS (a solution of poly(3,4-ethylenedioxythiophene) (“PEDOT”) and polystyrenesulfonic acid (“PSS”) (available as Baytron P from H C Starck). The HIL/ABL 215 can have a thickness from about 5 nm to about 1000 nm, and is conventionally used from about 50 to about 250 nm.

Other examples of the HIL/ABL 215 include any small molecule materials and the like such as plasma polymerized fluorocarbon films (CFx) with preferred thicknesses between 0.3 and 3 nm, copper pthalocyanine (CuPc) films with preferred thicknesses between 10 and 50 nm.

The HIL/ABL 215 can be formed using selective deposition techniques or nonselective deposition techniques. Examples of selective deposition techniques include, for example, ink jet printing, flex printing, and screen printing. Examples of nonselective deposition techniques include, for example, spin coating, dip coating, web coating, and spray coating. A hole transporting and/or buffer material is deposited on the first electrode 211 and then allowed to dry into a film. The dried film represents the HIL/ABL 215. Other deposition methods for the HIL/ABL 215 include plasma polymerization (for CFx layers), vacuum deposition, or vapor phase deposition (e.g. for films of CuPc).

EML 216:

The active light emissive layer (EML) 216 is comprised of an organic electroluminescent material which emits light upon application of a potential across first electrode 211 and second electrode 217. The EML may be fabricated from materials organic or organo-metallic in nature. As used herein, the term organic also includes organo-metallic materials. Light-emission in these materials may be generated as a result of fluorescence or phosphorescence. Examples of such organic electroluminescent materials include:

(i) poly(p-phenylene vinylene) and its derivatives substituted at various positions on the phenylene moiety;

(ii) poly(p-phenylene vinylene) and its derivatives substituted at various positions on the vinylene moiety;

(iii) poly(p-phenylene vinylene) and its derivatives substituted at various positions on the phenylene moiety and also substituted at various positions on the vinylene moiety;

(iv) poly(arylene vinylene), where the arylene may be such moieties as naphthalene, anthracene, furylene, thienylene, oxadiazole, and the like;

(v) derivatives of poly(arylene vinylene), where the arylene may be as in (iv) above, and additionally have substituents at various positions on the arylene;

(vi) derivatives of poly(arylene vinylene), where the arylene may be as in (iv) above, and additionally have substituents at various positions on the vinylene;

(vii) derivatives of poly(arylene vinylene), where the arylene may be as in (iv) above, and additionally have substituents at various positions on the arylene and substituents at various positions on the vinylene;

(viii) co-polymers of arylene vinylene oligomers, such as those in (iv), (v), (vi), and (vii) with non-conjugated oligomers; and

(ix) polyp-phenylene and its derivatives substituted at various positions on the phenylene moiety, including ladder polymer derivatives such as poly(9,9-dialkyl fluorene) and the like;

(x) poly(arylenes) where the arylene may be such moieties as naphthalene, anthracene, furylene, thienylene, oxadiazole, and the like; and their derivatives substituted at various positions on the arylene moiety;

(xi) co-polymers of oligoarylenes such as those in (x) with non-conjugated oligomers;

(xii) polyquinoline and its derivatives;

(xiii) co-polymers of polyquinoline with p-phenylene substituted on the phenylene with, for example, alkyl or alkoxy groups to provide solubility; and

(xiv) rigid rod polymers such as poly(p-phenylene-2,6-benzobisthiazole), poly(p-phenylene-2,6-benzobisoxazole), polyp-phenylene-2,6-benzimidazole), and their derivatives.

Other organic emissive polymers such as those utilizing polyfluorene include that emit green, red, blue, or white light or their families, copolymers, derivatives, or mixtures thereof. Other polymers include polyspirofluorene-like polymers, their families, co-polymers and derivatives.

Alternatively, rather than polymers, small organic molecules that emit by fluorescence or by phosphorescence can serve as the organic electroluminescent layer. Examples of small-molecule organic electroluminescent materials include: (i) tris(8-hydroxyquinolinato) aluminum (Alq); (ii) 1,3-bis(N,N-dimethylaminophenyl)-1,3,4-oxadazole (OXD-8); (iii) -oxo-bis(2-methyl-8-quinolinato)aluminum; (iv) bis(2-methyl-8-hydroxyquinolinato) aluminum; (v) bis(hydroxybenzoquinolinato) beryllium (BeQ.sub.2); (vi) bis(diphenylvinyl)biphenylene (DPVBI); and (vii) arylamine-substituted distyrylarylene (DSA amine).

The thickness of the EML 216 can be from about 5 nm to about 500 nm, preferably, from about 20 nm to about 100 nm, and more preferably is about 75 nm. The EML 216 can be a continuous film that is non-selectively deposited (e.g. spin-coating, dip coating etc.) or discontinuous regions that are selectively deposited (e.g. by ink-jet printing). EML 216 may also be fabricated by vapor deposition, sputtering, vacuum deposition etc. as desired.

In some embodiments, the EML 216 can be composed of at least two light emitting elements chosen, for example, from those listed above. In the case of two light-emitting elements, the relative concentration of the host element and the dopant element can be adjusted to obtain the desired color. The EML 216 can be fabricated by blending or mixing the elements, either physically, chemically, or both. The EML 216 can emit light in any desired color and be comprised of polymers, co-polymers, dopants, quenchers, and hole transport materials as desired. For instance, the EML 216 can emit light in blue, red, green, orange, yellow or any desired combination of these colors and in some applications, may include a combination of emitting elements which produce white light.

In addition to active electroluminescent materials that emit light, EML 216 can also include materials capable of charge transport. Charge transport materials include polymers or small molecules that can transport charge carriers. For example, organic materials such as polythiophene, derivatized polythiophene, oligomeric polythiophene, derivatized oligomeric polythiophene, pentacene, triphenylamine, and triphenyldiamine. EML 216 may also include semiconductors, such as silicon, gallium arsenide, cadmium selenide, or cadmium sulfide.

Second Electrode 217:

In the bottom-emitting configuration, the second electrode 217 functions as a cathode (the cathode is a conductive layer which serves as an electron-injecting layer and which comprises a material with a low work function). While the second electrode can be comprised of many different materials, preferable materials include aluminum, silver, gold, magnesium, calcium, cesium, barium, or combinations thereof. More preferably, the cathode is comprised of aluminum, aluminum alloys, or combinations of magnesium and silver. Additional cathode materials may contain fluorides such as LiF and the like. Second electrode 217 though shown as a single layer may be composed of a plurality of sub-layers composed of one or more of the above materials in any desirable combination.

The thickness of the second electrode 217 is from about 10 nm to about 1000 nm, preferably from about 50 nm to about 500 nm, and more preferably, from about 100 nm to about 300 nm. While many methods are known to those of ordinary skill in the art by which the second electrode 217 may be deposited, vacuum deposition and sputtering methods are preferred.

Enhancement Filter 230

OLED device 205 as shown is a bottom-emitting OLED, and thus, the light emitted from the EML 217 passes through the substrate 208. In accordance with various embodiments of the invention, an enhancement filter 230 is disposed on the exposed external side of the substrate 208 (and thus, on the exterior of the OLED device 205) to enhance the total light output from EL device 200. In at least one embodiment of the invention, the enhancement filter suppresses blue and red light emitted by OLED device 205 and enhances green or yellow light.

The chemical composition of the enhancement filter 230 can be for example, made of polycarbonate, polystyrene or polyester. The transmission and suppression characteristics of the enhancement filter emanate from the dye that is coated on the filter film or the deep dye that is used to fabricate the filter. Typically, the enhancement filter 230 is either surface dyed or deep dyed so that it achieves a certain spectral characteristic. The choice of dye determines which wavelength regions are depressed while the concentration of the dye determines the magnitude of the depression. The deep dye process is more durable and more resistant to fading as the dye is dispersed in the filter matrix itself. This spectral characteristic modifies the spectral output from the OLED device 205 by transmitting more in a selected region of the spectrum and less in another. For instance, in one embodiment, if the OLED device is emitting dominantly in red and blue, the levels of red and blue can be suppressed, and the level of green or yellow enhanced. The relative amount of blue and red suppressed will depend upon the desired output spectrum as well as the OLED emission spectrum. For instance, in some embodiments, an equal amount or equal proportion of both blue and red may be suppressed. In other embodiments, more or proportionally more red may be suppressed than blue or vice versa. If the OLED is emitting in white but with a more pinkish hue (more red) than is desired, the level of red may be reduced by choice of an enhancement filter 230 with the appropriate spectral characteristic. One desired result would be to enhance the contribution of a green or yellow region of the spectrum relative to red and blue to achieve a more ideal white. Thus, it is not necessary that green be specifically enhanced. It may be sufficient that red and/or blue are suppressed enough to give green/yellow more of a representation to the final output spectrum.

The enhancement filter 230 itself may have a thickness ranging from about 150 to 400 microns. In some embodiments, the enhancement filter 230 can be attached to the substrate 208 using an optically clear adhesive glue, which may additionally also be curable by ultraviolet radiation, or an index matching gel. In other embodiments, the enhancement filter 230 can be deposited or formed directly on substrate 208. Further, the enhancement filter 230 can utilize a cross-linkable material which can then be chemically bonded to the substrate 208.

Alternatively, the enhancement filter can be combined with any other film that is present on the OLED device, such as polarizers, scratch resistant films, antireflective films, brightness enhancing films, etc. This can be accomplished by incorporating the light absorbing dyes into these films directly.

Additionally, the enhancement filter is not required to cover the entirety of the light emitting area of the OLED device. The filter can be designed to cover any part of the display area in which adjustment of the emission color is needed.

Top Emitting OLED Devices

In an alternative configuration to that shown in FIG. 5 and described above, the first electrode 211 functions as a cathode (the cathode is a conductive layer which serves as an electron-injecting layer and which comprises a material with a low work function). The cathode, rather than the anode, is deposited on the substrate 208 in the case of, for example, a top-emitting OLED. In this alternative configuration, the second electrode layer 217 functions as an anode (the anode is a conductive layer which serves as a hole-injecting layer and which comprises a material with work function greater than about 4.5 eV). The anode, rather than the cathode, is deposited on the semiconductor stack 214 in the case of a top-emitting OLED.

In embodiments where the OLED is “top-emitting” as discussed above, the anode may be made transparent or translucent to allow light to pass from the semiconductor stack 214 through the top of the device. In such cases, the enhancement filter 230 would be attached, bonded or cured to the anode 217 (or to a glass or other material which encapsulates and protects the anode) rather than to the substrate 208 as with a bottom-emitting OLED shown in FIG. 5.

The OLED display/device described earlier can be used within displays in applications such as, for example, computer displays, information displays in vehicles, television monitors, telephones, printers, and illuminated signs.

What is claimed is:

1. An organic electroluminescent device, comprising:
an organic light emitting diode (OLED) emitting light in a first spectrum; and
a color enhancement filter disposed in the path of light emission from said OLED and external to said OLED, said filter shifting said first spectrum by enhancing a selected region of said first spectrum.

2. The device of claim 1 wherein said color enhancement filter shifts said first spectrum from a white to a more ideal white.

3. The device of claim 1 wherein said first spectrum is shifted by enhancing the green region of said first spectrum.

4. The device of claim 3 wherein said green region is enhanced at least in part by depressing the red region of said first spectrum.

5. The device of claim 3 wherein said green region is enhanced at least in part by depressing the blue region of said first spectrum.

6. The device of claim 3 wherein said green is enhanced at least in part by depressing the red and blue regions of said first spectrum.

7. The device of claim 1 wherein said enhancement filter is physically attached to said OLED.

8. The device of claim 1 wherein said enhancement filter is chemically attached to said OLED.

9. The device of claim 1 wherein said device is part of lighting source application.

10. The device of claim 1 wherein said OLED is bottom emitting.

11. The device of claim 1 wherein said enhancement filter is attached to a substrate of said OLED.

12. The device of claim 1 wherein said first spectrum is emitted by a light emitting layer comprised of at least one organic material.

13. The device of claim 12 wherein said organic material comprises a polymer.

14. The device of claim 13 wherein said polymer comprises a polyfluorene.

15. The device of claim 1 wherein said first spectrum is emitted by a light emitting layer comprised of at least one inorganic small molecule material.

16. The device of claim 1 wherein said color enhancement filter is integrated into one or more other filters disposed external to said OLED device.

17. The device of claim 1 wherein said color enhancement filter physically covers only a portion of said OLED.
